(19) United States
(12) Patent Application Publication
(10) Pub. No.: US 2009/0319189 A1
(43) Pub. Date: Dec. 24, 2009

(54) LOW COST, UNATTENDED WEATHER SENSOR

(75) Inventors: Alan Cornett, Andover, MN (US); Robert Charles Becker, Eden Prairie, MN (US); Jerome Paul Drexler, Wyoming, MN (US)

Correspondence Address: HONEYWELL INTERNATIONAL INC.;PATENT SERVICES AB-2B, 101 COLUMBIA ROAD, P.O. BOX 2245, MORRISTOWN, NJ, 07962-2245, US

(73) Assignee: HONEYWELL INTERNATIONAL INC., Morristown, NJ (US)

(21) Appl. No.: 12/144,460

(22) Filed: Jun. 23, 2008

(51) Int. Cl. G01W 1/02

(52) U.S. Cl. 702/3

(57) ABSTRACT

A weather sensor system for gathering and transmitting weather related information. The system integrates information gathered from a barometer, temperature sensor, hygrometer, GPS, tilt sensor, and an anemometer. The anemometer assembly is a combined wind speed and direction sensor and radio antenna. The weather sensor data can be transmitted from a remote location and relay data to central collection point or network location.

### BACKGROUND OF THE INVENTION

At present there are no low cost, easily portable weather sensors systems and/or weather stations available for military or similar unattended use. Many of the available weather stations are component systems. The closest match to the requirements of a low cost, portable weather station is a Kestral 4000. However, this device is a local device that does not relay weather data to an upstream central repository. Furthermore the Kestral 4000 is a hand held, and is therefore not intended for unattended operation, requiring the operator to manually point the device into the wind in order to measure wind speed.

As exemplified in the above example of the Kestral 4000, one of the biggest hurdles to establishing an unattended gathering and transmission device to monitor weather is in the specific gathering of wind related information. Despite the fact that there are many prior devices and attempts, many devices have shortcomings that make their adoption impractical for the intended purpose. For example cup and vane anemometers are by far the most prevalent type of anemometer, but have drawbacks related to the moving parts. The weathervane device requires very free gimbals so as to allow the device to point accurately into the wind at very low wind speeds. As a result of its reliance on this mechanist element, the anemometer is not conducive to measuring gusts, and is subject to errors in measurement due to overshoot, oscillations that occur due to change in wind direction, and wind measurement even when the wind is not blowing. Moreover, because of the reliance on moving parts, cup and vane anemometers tend to wear and degrade in performance over time, and therefore are not optimal for unattended operation.

Still another type, a sonic anemometer uses sound waves to measure wind direction and speed. These are a class of instruments that are typically used by research and other scientific organizations. These systems use the changes in the speed of sound as measure over a finite path. Whilst these instruments overcome the failings of the more prevalent cup and vane they cost considerably more to purchase and maintain. Also, the sonic devices tend to be very power hungry, so although they may be suitable for unattended operation, considerable cost and compensatory power mechanisms must be built into the device for continuous remote operation.

Low maintenance, simplified anemometers are known, typically employing a vertical shaft sensor design with few moving parts. Such designs however, tend to be inaccurate and do not lend themselves to unattended use, or otherwise have complex detection methods, and therefore in design, they tend to be ineffective solutions to remote unattended use. In one example, Shoemaker (U.S. Pat. No. 7,117,735), a simple, single pickup wind drag force measurement system using a vertical rod is used. However, although this design addresses the cost threshold, the accuracy of measurement is modest. Moreover, the device is sensitive to inclinations of the device, and has no built in device as a compensatory mechanism correcting for the inaccuracies that would result if the device wasn't positioned in a true vertical.

Gerardi (U.S. Pat. No. 5,117,687), another vertical shaft sensor design uses a sphere attached to a shaft. When the wind force moves the shaft, electromagnetic or optical sensors detect the deflection from the neutral position. The air data sensor uses a relative difference method to measure deflection using 4 orthogonally placed sensors in addition to two more sensors for complete 3-axis velocity measurements. One drawback to this design is the excessive use of strain gauges contributing to the overall complexity of the design. Moreover, this invention requires a counterweight to function in an inclination independent manner.

Another difficulty with complex design is in the ability to transport the device. Portable wind sensors typically involve a weathervane structure that points a fan-based anemometer in the direction of the wind to measure wind speed. Other types of portable anemometers require the operator to point a fan-based device into the wind. These are generally unsuitable for unattended operation, suffering from inaccuracies in measurement and are generally less sensitive than more expensive designs.

A need exists for a low cost, unattended weather data gathering device, to collect data related to temperature, relative humidity, barometric pressure and global position, as well as an accurate, low maintenance device for detecting wind related information. Moreover, the device should be easily portable, with a fully integrated transmission device to transmit data from a remote location to a central data repository.

### SUMMARY OF THE INVENTION

This invention relates generally to a portable weather sensor system and/or weather station, more specifically, to a system and method for unattended wind speed, wind direction, temperature, and relative humidity detection with a built-in global positioning device and integrated transmission device to measure and transmit gathered weather data to a central data repository.

One embodiment of the present invention is a system that integrates aspects of a weather station by employing a barometric pressure sensor, temperature sensor, GPS receiver, a humidity sensor, digital compass, wind direction and wind speed sensor with a tilt sensor, along with a microprocessor system, battery, and an antenna for the datalink radio to relay data to a collection/processing point. The GPS provides world-wide unambiguous spatial, geographic position reporting. The barometer, temperature sensor, and hygrometer provide substantially complete weather data in a single integrated, portable unit. The digital compass indicates magnetic north relative to the sensor platform, and when combined with known magnetic deviations based on global position, can determine the direction of true north relative to the orientation of the weather station. This allows the weather station to provide true wind direction without regard to the rotation of the station base relative to true north.

An element of the present invention is directed to an anemometer assembly that is a combined wind speed and direction sensor plus radio antenna. The wind sensor measures relative wind direction and speed without the use of moving parts and consumes very little power making it suitable for unattended operation. The main wind sensor is a vertical member that can be used as a radio antenna for a datalink. The data can be transmitted from a remote location to a central collection point or network location.

### BRIEF DESCRIPTION OF THE DRAWINGS

Preferred and alternative examples of the present invention are described in detail below with reference to the following drawings:

FIG. 1 is a flow schematic of an exemplary unattended weather sensor system;

FIG. 2-1 is a schematic top view illustrating the orientation of the sensors of the anemometer assembly of one embodiment of the present invention;

FIG. 2-2 is a schematic top view of a tilt sensor;

FIGS. 2-3 and 2-4 are schematic drawings of two sets of exemplary strain gauges;

FIG. 3 is a cross-sectional and front view of an exemplary embodiment of the present invention; and

FIG. 4 is a flow diagram depicting the operation of the weather sensor system.

### DETAILED DESCRIPTION OF THE PREFERRED EMBODIMENT

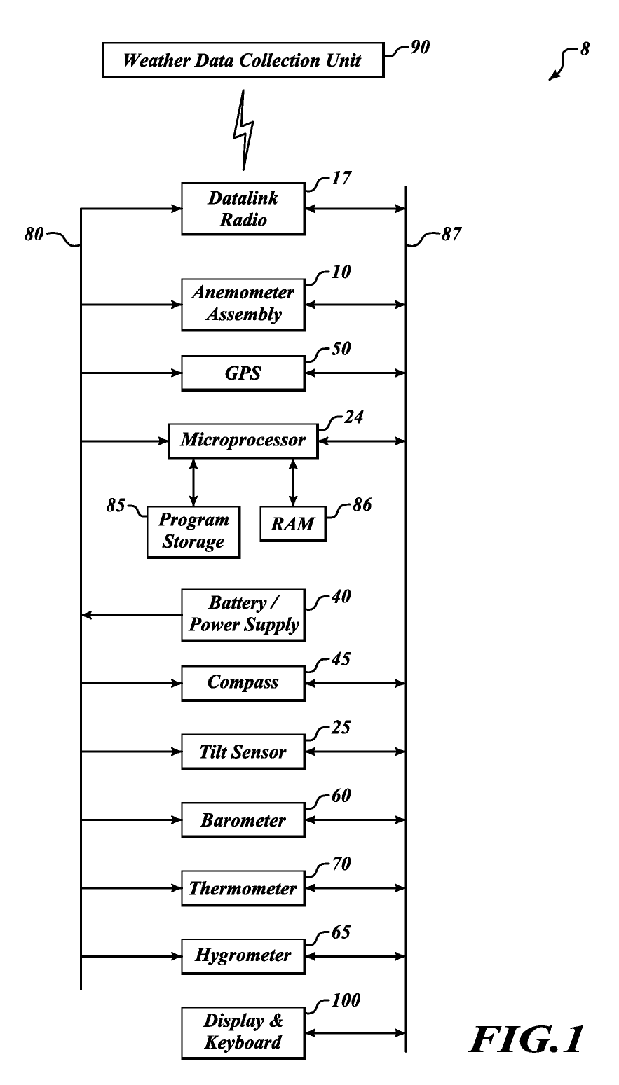

FIG. 1 shows component parts of a weather sensor system 8 that includes weather sensors and system instruments. For example, weather sensors can include, but are not limited to: an anemometer assembly including an integrated radio antenna 10 (discussed in detail below) for measuring wind speed and direction and transmitting weather related data from the weather system 8; a barometric pressure sensor 60 (such as the MPX2102A absolute pressure sensor from Freescale Semiconductor); a humidity sensor 65 (which is preferably an HS1101LF by Humirel); and a temperature sensor and/or thermometer 70 (such as the DS7505 from Maxim Integrated Products). System instruments, can include for example, but are not limited to: a battery and/or other internal power supply 40. Examples of the power supply 40 includes any suitable power source including a plurality of batteries. Magnetic orientation data is provided by a three-axis compass 45 which is preferably and HMC2043 by Honeywell) and a global positioning system (GPS) receiver 50 which is preferably a GlobalSat Technology EM-411 for receiving GPS location information from the weather sensor system 8. The three-axis compass 45 indicates the direction of magnetic north and is unaffected by tilting of the compass. A datalink radio 17 which in one non-limiting embodiment can be a WiMax data link is a means for transmitting formatted weather sensor data and system instrument data to a weather data collection unit 90. The weather data collection unit 90 in one exemplary embodiment is a matching datalink radio to datalink radio 17 attached to a personal computer for data storage and display. A tilt sensor and or meter 25 which in an non-limiting embodiment is an electrolytic tilt sensor such as the TrueTilt products from the Fredericks Company is also included.

Also included are data processing system components including a power bus 80 to supply power to the devices in the weather sensor system 8 including the datalink radio 17. Databus 87 provides a common interconnection between a microprocessor 24 and the weather sensor devices, datalink radio 17 and keyboard and display 100. Program memory 85, 86 (which is typically a combination of Random-Access Memory 86 and Read-Only memory 85 and can be any suitable form) is a means for storing configuration and program information and other data, for example, the temporary storage of raw data from weather sensors (e.g. including data from 10, 60, 65, 70) and system instruments (e.g. including data from 25, 45 50). Formatted weather data may also be stored in Random Access Memory 86 prior to sending to datalink radio 17 for transmission.

The microprocessor 24 can integrate data input from the weather sensor system 8 component parts, which can be queried at selected time intervals, for example at predetermined timed intervals or upon command. In one example a user can initiate the query of the weather sensor system 8 via a wireless connection using the datalink radio 17 or using local access (for example from the display and keyboard 100 of the user interface). In another embodiment, the weather sensor system 8 collects and transmits data from each of the weather sensor system 8 components according to a timed schedule. In either example, when the weather sensor system 8 receives a data request, or at the commanded time, can selectively power up, initiate weather data collection and transmit to the weather data to a weather data collection unit 90, where all collected data can be correlated with that time period. The weather data can be, for example, either sensor measurement information (e.g. from the tilt sensor 25), or measurements from the hygrometer (humidity sensor) 65, barometric pressure sensor, 60 and/or compass 45 or integrated measurements from a plurality of the sensors, (e.g calculated wind speed and direction data calculated from load cells 18, 19, 20, and 21 with corrections for tilt based on measurements from tilt sensor 25 and corrected for orientation to true north based on data from 3-axis compass 45 and local magnetic deviation based on geographic location as determined by GPS receiver 50). Weather sensor and system instrument data can be formatted by the microprocessor 24 and transmitted as a data message using formats similar to, in this non-limiting example, the National Marine Electronics Association (NMEA) formats used to transmit position data between devices.

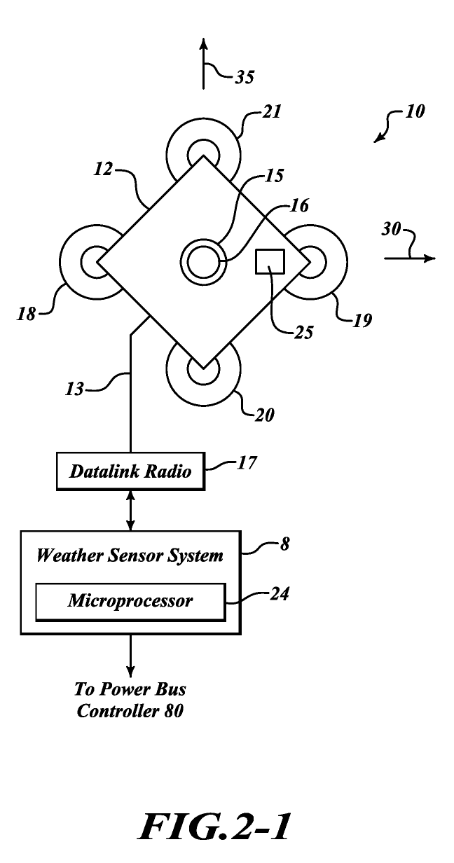

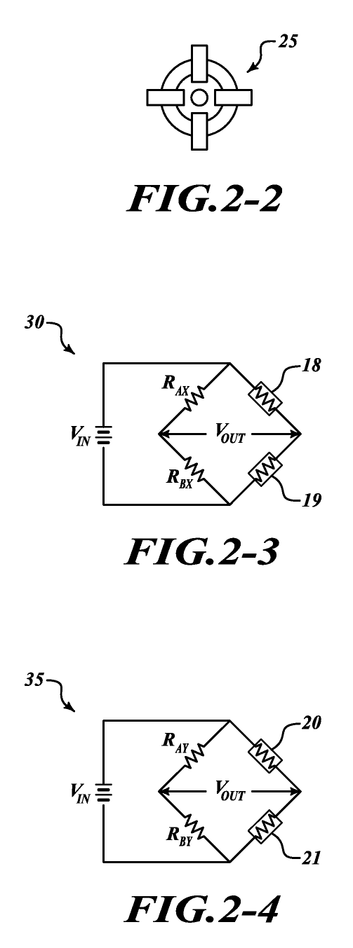

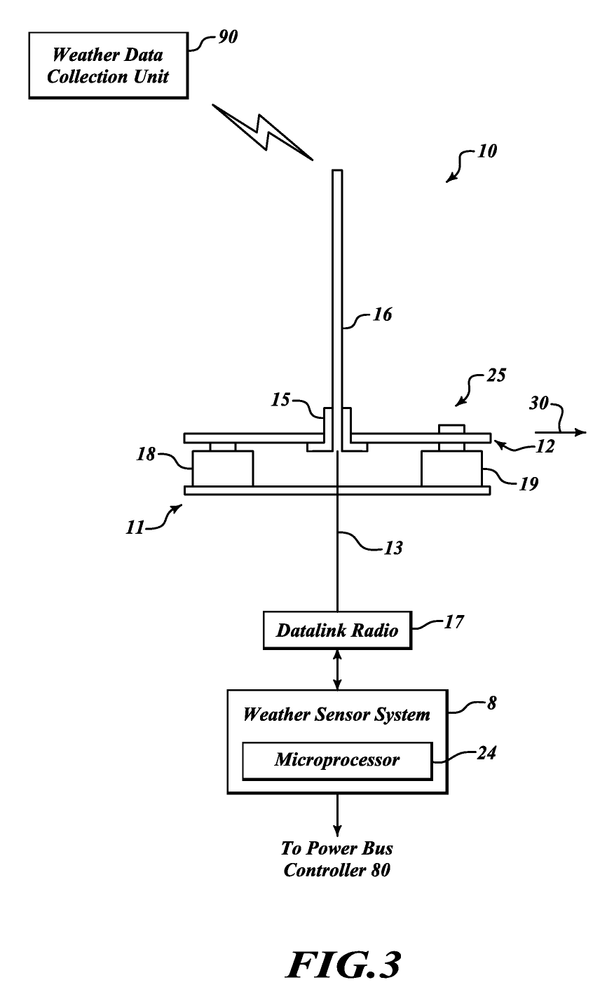

A datalink radio 17 attached to the elongated vertical member plus radio antenna 16 (described further in FIGS. 2-1, 3) of the anemometer assembly 10 is a means for transmitting formatted weather sensor and system instrument data to the weather data collection unit 90 for storage. The anemometer assembly as further described in FIG. 2-1 and below, is in communication with the sub-system elements of the anemometer assembly 10, and the sub-system elements of the weather sensor system 8. The weather sensor system 8 is a means for processing wind speed and wind direction from the raw weather sensor data and is enabled to process correction data from the tilt sensor 25 (FIG. 2-2) to adjust weather sensor data originating from the anemometer load sensors (see FIG. 2-1). For example, if the anemometer assembly 10 is inclined at an angle when in the field, that inclination causes deviation of the elongated vertical member 16 from a true vertical position. Therefore, the tilt sensor 25 (see FIGS. 2-2, 3) provides inclination adjustment data such that the load sensor deflection data can be adjusted to compensate for the deviation, thereby yielding accurate wind speed and wind direction data. The weather sensor system 8 can also include a means for presenting the weather sensor and system instrument data to a user in response to a user initiated query of the weather sensors and system instruments, for example a computer display and keyboard 100 with a graphic user interface.

FIG. 2-1 and FIG. 2-2 shows a schematic top view of an exemplary embodiment of a an anemometer assembly 10 of the present invention, that includes a plurality of opposing load sensors 18 and 19 located on an X-axis 30, and load sensors 20 and 21 located on an Y-axis 30, a sensor plate 12; a main wind sensor that is an elongated vertical member/antenna 16; an insulating bushing 15, an antenna lead 13, a tilt sensor 25 (FIG. 2-2), and a datalink radio 17 having a microprocessor 24. The tilt sensor 25 (FIG. 2-2) is positioned on the sensor plate 12 to detect the angle of inclination of the device and generate correction data. The load sensors 18-21 are connected at corners of sensor plate 12 and a base structure 11 (FIG. 3). The load sensors 18-21 are in signal communication with the microprocessor 24.

The sensor plate 12 is mounted on top of the plurality of load sensors 18, 19, 20, 21 preferably at 90 degree angles to each other, each load sensor 18, 19, 20, 21 positioned at a corner of the sensor plate 12, each load sensor 18, 19, 20, 21 is positioned to sense a load in a direction unique from that of the other. Opposing load sensors 18 and 19, in this example, are along the X axis 30 in relationship to the sensor plate 12; and opposing load sensors 20 and 21 are located along a Y axis 35. Each load sensor 18, 19, 20, 21 makes indirect contact with the elongated vertical member 16 through the sensor plate 12. Each load sensor 18, 19, 20, 21 detects and measures a load force associated with deflections of the elongated vertical member 16 and transmits any such measured deflection data to the microprocessor 24.

The elongated vertical member 16 is also a radio antenna for transmitting the formatted weather sensor data generated by weather sensor system 8 by the local datalink radio 17, such as, but not limited to, a WiMax data radio to the weather data collection unit 90 (See FIG. 3). The elongated vertical member 16 is substantially freestanding and designed to be physically deflected in the direction of any wind flow when placed in such a wind flow stream. The amount of deflection is proportional and directional to the velocity and direction of any such wind flow. The insulating bushing 15, positioned at an opening in the sensor plate 12, insulates the elongated vertical member 16 from the sensor plate 12 allowing the elongated vertical member 16 to transmit radio signals without interference. The elongated vertical member 16 is secured to the insulating bushing 15 and the insulated bushing 15 is secured to the sensor plate 12. The antenna lead 13 connects the elongated vertical member/antenna 16 to the datalink radio 17.

The microprocessor 24 converts load sensor 18-21 voltage to wind speed. Wind speed in each axis is then corrected for tilt in the sensor plate 12, and the corrected wind speeds in each axis are converted to resultant wind speed and direction. The microprocessor 24 then corrects the wind direction for rotation of the sensor plate 12 using data from the 3-axis magnetic compass 45. The magnetic direction of the wind is then compensated for magnetic deviation by magnetic deviation data derived from the geographic location of the weather station as determined by GPS receiver 50. The resulting wind direction is expressed relative to true (geographic) north. Microprocessor 24 formats the wind and weather data and sends it to datalink radio 17 where it is transmitted to weather data collection unit 90 (FIG. 3).

The tilt sensor 25 (FIGS. 2-2, 3) produces tilt data that is used to correct for variations in inclination of the anemometer assembly 10, and accurately calibrate the force on the elongated vertical member 16. For example, a semi-conductor MEMS (micro electronic machined semiconductor) device or an electrolytic tilt sensor (e.g. TrueTilt products from the Fredericks Company) can be used to provide for the correction details. The force due to inclination of elongated vertical member 16 from true vertical acts as if the mass of elongated vertical member 16 is located at the midpoint of the element. The force on the sensor plate 12 due to inclination from vertical is equal to the Sine of the angle of inclination from vertical multiplied by the length of elongated vertical member 16 divided by the distance between opposing load cells. To correct for inclination errors, this force is subtracted from the measured force due to wind to determine the true wind induced force on elongated vertical member 16.

Turning to back to FIG. 2-1 and referring to FIGS. 2-3 and 2-4, opposing load sensors 18 and 19, 20 and 21 form two legs of a Wheatstone bridge circuit. In one preferred orientation of the load sensors 18, 19, 20, 21 is at 90 degree angles apart from each other to provide orthogonal force measurements that can be used with vector analysis to determine wind direction. The total force applied to the elongated vertical member 16 can be resolved by vector addition of the individual component forces.

In FIG. 2-3, a first Wheatstone bridge circuit 18-19 includes a high side of an input voltage V_{IN} is connected to a first side of the first load cell 18^{-L} and resistor R_{AX}. The low side V_{IN} is connected to a first side of a second load cell 19^{-L} and resistor R_{BX}. A voltage out V_{OUT} is sampled across a node of the second sides of R_{AX} and R_{BX} and a node of the second sides of the load cells 18^{-L}, 19^{-L}. A change in the resistance value of the load cells 18^{-L}, 19^{-L} correlates to an applied strain. Because the orthogonal wind axis, i.e. axis along which the wind is blowing, can act as a pivot point, the particular load cells used for this application preferably respond to both tensile and compressive forces.

For example, the standard arrangements as shown in the schematic diagrams FIGS. 2-3 and 2-4, can have two resistive strain gauges and two fixed or unstrained resistors to measure aerodynamic forces in each in each of the two orthogonal directions: εTx is the total strain in along the X axis 30, and εTy is the total strain along the Y axis 35. Total strain for each of the two orthogonal directions can be given by the equations:

εTx=εRAx−εrBx+εR18−εR19 (1)

εTy=εRAy−εrBy+εR20−εR21 (2)

Where εTx=total strain in the x direction;

εTy=total strain in the y direction

εRAx=total strain on resistor Ax in the x direction

εRAy=total strain on resistor Ay in the y direction

εRBx=total strain on resistor Bx in the x direction

εRBy=total strain on resistor By in the y direction

εR18=strain on element 18 in the x direction

εR19=strain on element 19 in the x direction

εR20=strain on element 20 in the y direction

εR21=strain on element 21 in the y direction

Ax, Ay, Bx and By are fixed resistors or unstrained resistance strain gauges.

Signals generated by the load sensors 18, 19, 20, 21 include, for example, static strain due to the drag of the elongated vertical member 16 and are proportional to the square of the wind velocity. The generated signals from the load sensors 18, 19, 20, 21 are sent to the microprocessor 24. The microprocessor 24 simultaneously receives the generated signals from at least two load sensors 18, 19, 20, 21. Inclination of the sensor plate 12 from perfectly flat introduces load signal in load sensors 18, 19, 20, and 21 that would appear as wind if not corrected for. Inclination of sensor plate 12 is measured by tilt sensor 25. The tilt data generated by tilt sensor 24 is used by microprocessor 24 to correct the force measurements from load sensors 18, 19, 20, and 21 for errors due to inclination of the sensor plate 12. The tilt sensor 24 can be calibrated prior to operation if it is not self calibrating. A correction coefficient relating tilt angle to force on the load sensors (18, 19, 20, 21) is dependent on the height and weight of elongated vertical member 16.

In a preferred embodiment, a rigid material is used for the elongated vertical member providing for simple moment arm calculations (i.e. moment calculated by force multiplied by the lever arm length) to establish the correction factor for tilt. If, for example, the elongated vertical member 16 can bend substantially in the wind because of inherent flexibility, calculation of wind velocity becomes significantly more complex, as the moment arm of the sensing element is no longer a second-order function of wind velocity at high wind speeds, A vector wind speed algorithm, for example as discussed above (See Equations 1 and 2), is carried out by a microprocessor unit 24 (FIG. 3) to solve the load force equation for velocity in each axis 30, 35, applying the proper calibration coefficients to the drag for (as described in Equation 3) and tilt sensor 25 (FIGS. 2-2, 3) data. The microprocessor 24 corrects the load sensor voltage data for tilt and converts the corrected load sensor voltage data to wind speed along each axis. Wind speed in each axis is then converted to resultant wind speed and relative direction. The wind direction and speed is then formatted by microprocessor 24 and sent to datalink radio 17 for transmission.

FIG. 3 is a cross-sectional view of an anemometer assembly 10 along an X-axis 30, showing two opposing load sensors 18, 19, a rigid mounting platform 11, the sensor plate 12, and further incorporating some of the features of the present invention.

The anemometer assembly 10 as described above, measures the speed or velocity and direction of wind flowing over a surface and includes the sensor plate 12 having a means, such as an opening, for being connected to the elongated vertical member 16. The sensor plate opening in conjunction with the insulating bushing 15 is a means for securing the elongated vertical member substantially perpendicularly within any such wind flow. The elongated vertical member 16 is connected to and extends perpendicularly through the sensor plate 12, through the insulating bushing 15, connecting with the antenna lead 13 and the datalink radio 17.

The four load sensors 18-21 are mounted on a rigid platform 11. The rigid platform 11 and the sensor plate 12 are separated by a gap, such that the rigid platform is parallel to and underneath to the sensor plate 12. The elongated vertical member 16 is secured to the rigid platform and extends substantially perpendicularly from the rigid platform with the elongated vertical member being substantially freestanding and designed to be physically deflected when placed in a wind flow. The antenna lead is substantially protected from wind disturbance by its position within the space between the sensor plate 12 and the rigid platform 11.

The elongated vertical member 16 is preferably made of stainless steel or some other suitably rigid, conductive material with a height between approximately 14 inches to 36 inches and a ratio of height to diameter of approximately 30:1 for sensing wind speeds from approximately 10-120 mph. The dimensions of the elongated vertical member 16 are chosen to optimize the range of wind speeds detectable. For example if the elongated vertical member 16 is too long and/or too thin it will not withstand strong winds. On the other hand if the elongated vertical member 16 is too thin and/or too short it will not be responsive to low wind velocities. With these considerations in mind, the elongated vertical member 16 is selected to provide a desirable range of strain values. Preferably an elongated vertical member 16 will be in the range of 0.35-0.75 inches in diameter.

The force (F) acting on the elongated vertical member 16 is proportional to the square of the wind speed (V); signal generated from the load sensors increases with increased wind velocity. By measuring force (F) while knowing the other parameters (including the dimensions of the elongated vertical member 16, the velocity is derived by the equation:

V=[2F/C_{d} ρ 1 d]^{1/2} (3)

where C_{d} is the drag coefficient of the elongated vertical member; ρ is the density of the fluid (air), 1 and d are the length and diameter of the elongated vertical member, and V is the free stream velocity of the wind. Because the force due to the wind on the mounted elongated vertical member 16 is measured in two axes (X 30 and Y 35), the anemometer assembly 10 measures the vector components of the local wind. Therefore using a rectangular to polar coordinate system conversion, both wind speed and direction can be inferred.

The local microprocessor 24 processes the raw wind sensor measurement data information and uses tilt sensor 25 data to calculate the correct wind speed and direction. Magnetic compass 45 is used to determine the magnetic orientation of weather station including weather sensor system 8 so that microprocessor 24 can calculate the wind direction relative to magnetic north regardless of the orientation of weather station. The magnetically oriented wind direction is then corrected for magnetic deviation by using known magnetic deviation from true north based on the geographic location of weather station as determined by GPS unit 50. The wind direction and speed relative to true north, temperature, humidity, barometric pressure, and weather station geographic location information is then formatted for transmission by the datalink radio 17 to a weather data collection unit 90, including a means to store and display the received weather data. The elongated vertical member 16 is also a radio antenna for transmitting the data to the weather data processing unit 90. An antenna lead 13 connects the elongated vertical member 16 to the datalink radio 17.

The weather data collection unit 90, which can be, but is not limited to, a central computer enabled data repository that receives the formatted signals from the datalink radio 17 and local microprocessor 24 and stores this information for later retrieval.

Wind speed is derived from manipulation of the raw data, and equal to the square root of the sum of the square of the wind speeds along the two axes as detected by opposing load sensors. Wind direction is derived from values detected by the load sensors, and is calculated as the inverse tangent of the ratio of the wind speed in the Y-axis 35 to the wind speed in the X-axis 30.

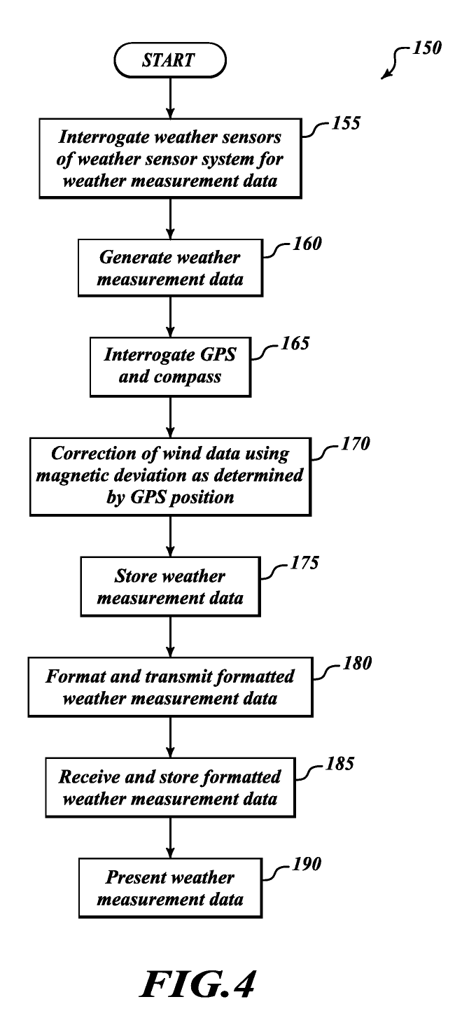

Turning to FIG. 4 a flow chart illustrates a system 150 for measuring and transmitting weather data as practiced according to one embodiment of the invention. In operation at a Block 155 the weather sensor system 8 can be queried for weather sensor and system instrument data, which can be, for example at an automatic and scheduled time interval, or by an initiated query by a remote user. At a Block 160 weather sensor data, including barometric pressure, humidity, temperature, global position, tilt, and wind speed and direction is generated and sent to the microprocessor 24. At block 165, the GPS is interrogated for geographic location and magnetic compass 45 is interrogated for magnetic orientation of the weather sensor system 8. Next at a Block 170, the wind direction is corrected for orientation of the weather sensor system 8 to magnetic north and further corrected for magnetic deviation from vertical to provide wind direction relative to true (geographic) north. Next at a Block 175, the microprocessor 24 stores the weather data. At block 180, the stored weather data is formatted and transmitted via the datalink radio 17 to a weather data collection unit 90, which can be, for example, a central data repository computer. The elongated vertical member 16 is also the radio antenna for the datalink radio 17. The insulating bushing 15 positioned at an opening in the sensor plate 12, insulates the elongated vertical member 16 from the sensor plate 12 allowing the elongated vertical member 16 to transmit radio signals without interference.

At block 185, the transmitted weather data is received and stored in weather data collection unit 90. At block 190, the weather data in the central repository is retrieved for presentation or analysis. Weather data collection unit 90 includes means for further analysis of weather data and display of weather data already stored.

While the preferred embodiment of the invention has been illustrated and described, as noted above, many changes can be made without departing from the spirit and scope of the invention. For example, simple software modifications enable this, allowing for updates to keep this invention useful for the foreseeable future; and a wide variety of materials can be used for the component parts and a variety of load cells and tilt sensors can be used without departing from the spirit of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A weather sensor system comprising:
a plurality of weather sensors and system instruments;
an anemometer assembly with radio antenna comprising
a rigid mounting platform;
an elongated vertical member;
a sensor plate spaced apart from said rigid platform, the sensor plate having an opening, a bushing being received in the opening, wherein the elongated vertical member extends through the sensor plate opening and through the bushing;
a tilt sensor attached to the sensor plate sensor configured to generate inclination data;
a plurality of load sensors positioned substantially beneath and in contact with the sensor plate, each load sensor configured to sense a load caused motion of the sensor plate due to movement of the elongated vertical member; and
a component configured to receive signals from at least two load sensors of the anemometer assembly, weather sensor data, and system instrument data from the weather sensors and the system instruments;
a component configured to calculate relative wind direction and wind speed;
a component for correcting relative wind direction to true north;
a component for storing wind direction and wind speed, weather measurement data, and system instrument data; and
a component configured to transmit formatted wind direction and wind speed, weather measurement data, and system instrument data to a weather data collection unit; and
a weather data collection unit for collecting weather data, weather sensor data, and system instrument data.

2. The weather sensor system of claim 1, further comprising a component configured to process sensor plate deflection data, weather sensor data, and system instrument data, including a means to derive the speed and direction of any wind flow.

3. The weather sensor system of claim 2, wherein the component configured to process sensor plate deflection data, weather sensor data and system instrument data is a microprocessor.

4. The weather sensor system of claim 1, wherein the plurality of load sensors of the anemometer assembly comprises four load sensors positioned at 90 degree angles to each other, each load sensor having contact with the elongated vertical member through the sensor plate.

5. The weather sensor system of claim 1, wherein the component configured to transmit the formatted wind direction and wind speed data, weather measurement data, and system instrument data to the weather data processing unit is via the datalink radio and the elongated vertical member that is a radio antenna.

6. The weather sensor system of claim 1, wherein the component configured to transmit the formatted wind direction and wind speed data, weather measurement data, and system instrument data to the weather data collection unit is the elongated vertical member that is a sizably adjustable radio antenna.

7. The weather sensor system of claim 1, wherein the plurality of weather sensors and system instruments further comprise:
a global positioning system receiver for determining a spatial geographic location of the weather station;
a barometric pressure sensor;
a temperature sensor;
a humidity sensor; and
a compass.

8. The weather sensor system of claim 1, further comprising a user interface for presenting the wind direction and wind speed, weather sensor data, and weather system instrument data to a user in response to a user initiated query of the weather sensors for weather sensor data.

9. A weather sensor measuring and data transmitting system comprising:
a plurality of weather sensors and system instruments;
an anemometer assembly with radio antenna comprising
a rigid mounting platform;
an elongated vertical member;
a sensor plate spaced apart from said rigid platform, the sensor plate having an opening, a bushing being received in the opening, wherein the elongated vertical member extends through the sensor plate opening and through the bushing;
a tilt sensor attached to the sensor plate sensor configured to generate inclination data;
a plurality of load sensors positioned substantially beneath and in contact with the sensor plate, each load sensor configured to sense a load caused motion of the sensor plate due to movement of the elongated vertical member; and
a means for receiving signals from at least two load sensors of the anemometer assembly, weather sensor data, and system instrument data from the plurality of weather sensors and the system instruments;
means for transmitting formatted weather sensor and system instrument data to a weather data processing unit;
means for calculating wind speed and wind direction from raw weather sensor data including correcting for the angle of inclination of the anemometer assembly and deviation of the elongated vertical member from a true vertical position; and
means for presenting the weather sensor and system instrument data to a user.

10. The weather sensor measuring and data transmitting system of claim 8, wherein the plurality of load sensors comprises four load sensors positioned at 90 degree angles to each other, each load sensor having contact with the elongated vertical member through the sensor plate.

11. The weather sensor measuring and data transmitting system of claim 8, wherein the means for transmitting the weather sensor and system instrument data to a weather data processing unit is the elongated vertical member that is a radio antenna.

12. The weather sensor measuring and data transmitting system of claim 8, wherein the means for transmitting the weather sensor and system instrument data to a weather data processing unit is the elongated vertical member that is a sizably adjustable radio antenna.

13. The weather sensor measuring and data transmitting system claim 8, wherein the plurality of weather sensors and system instruments further comprise:
a global positioning system receiver for determining a spatial geographic location of the weather station;
a barometric pressure sensor;
a temperature sensor;
a humidity sensor; and
a compass.

14. A weather sensor and data transmitting method comprising:
querying a plurality of weather sensors and system instruments of a weather sensor system for weather sensor and system instrument data;
formatting weather sensor and system instrument data from the plurality of weather sensors and system instruments;
receiving and storing formatted weather sensor and system instrument data, wherein at least one of the weather sensors comprise an anemometer assembly and radio antenna wherein the anemometer assembly and radio antenna further comprise:
an elongated vertical member extending substantially perpendicularly from a rigid platform with the elongated vertical member being substantially freestanding and designed to be physically deflected when placed in a wind flow, the amount of deflection being proportional to the velocity of any such wind flow, and in the direction of any such wind flow, said elongated vertical member also being the radio antenna;
transmitting formatted weather sensor and system instrument data to a weather data processing unit;
receiving any such formatted weather sensor and system instrument data from the plurality of weather sensors and system instruments;
storing formatted weather sensor and system instrument data from the plurality of weather sensors; and
presenting the weather sensor and system instrument data to a user in response to the query of the weather sensors and system instruments.

15. The weather sensor and data transmitting method of claim 13, wherein the anemometer assembly further comprises:
a rigid mounting platform;
a sensor plate spaced apart from said rigid platform, the sensor plate defining an opening to house a plurality of load sensors, and with the elongated vertical member extending through the sensor plate opening and through an insulating bushing, for deflection in response to any such wind flow.

16. The weather sensor and data transmitting method of claim 13, wherein the plurality of load sensors comprises four load sensors positioned at 90 degree angles to each other, each load sensor having contact with the elongated vertical member through the sensor plate.

17. The weather sensor and data transmitting method of claim 13, wherein transmitting the weather sensor and system instrument data to a weather data collection unit is by datalinked radio in communication with the elongated vertical member that is a radio antenna.

18. The weather sensor and data transmitting method of claim 13, wherein transmitting weather sensor and system instrument data to a weather data collection unit is by datalinked radio in communication with the elongated vertical member that is a sizably adjustable radio antenna.

19. The weather sensor and data transmitting method of claim 13, wherein calculating wind speed and wind direction from formatted weather sensor and system instrument data includes correcting for the angle of inclination of the anemometer assembly and deviation of the elongated vertical member from a true vertical position, wherein the correction data is received from a tilt sensor mounted on the sensor plate of the anemometer assembly, and the tilt sensor data is used to calculate the true wind speed and direction and the true wind speed and direction is transmitted simultaneously with the plurality of weather sensor data.

20. The weather sensor measuring and data transmitting method of claim 13, wherein the plurality of weather sensors and system instruments further comprise:
a global positioning system receiver for determining a spatial geographic location of the weather station;
a barometric pressure sensor;
a temperature sensor;
a humidity sensor; and
a compass.
